(19) United States
(12) Patent Application Publication
(10) Pub. No.: US 2024/0326167 A1
(43) Pub. Date: Oct. 3, 2024

(54) MANUFACTURING METHOD OF STRUCTURE, STRUCTURE, AND IMAGE FORMING APPARATUS

(71) Applicant: KYOCERA Document Solutions Inc., Osaka (JP)

(72) Inventors: Hiroki Ozawa, Osaka (JP); Koichiro Tsujimoto, Osaka (JP); Yoshiki Aoyama, Osaka (JP)

(21) Appl. No.: 18/620,339

(22) Filed: Mar. 28, 2024

(30) Foreign Application Priority Data
Mar. 29, 2023 (JP) 2023-053219

(51) Int. Cl. B23K 26/21; G03G 21/16

(52) U.S. Cl. CPC B23K 26/21; G03G 21/1619

(57) ABSTRACT

A first through-hole is formed on a target side wall in a specific pipe of a structure, and a second through-hole is formed on an opposing side wall which opposes the target side wall. A manufacturing method of the structure includes arranging a specific member along an outer surface of the target side wall. The manufacturing method further includes radiating laser light of a laser welder onto a first bonding region via the second through-hole on the opposing side wall, to weld the specific pipe and the specific member in the first bonding region. The first bonding region includes a boundary between an edge portion of the first through-hole on the target side wall and the specific member.

### INCORPORATION BY REFERENCE

This application is based upon and claims the benefit of priority from the corresponding Japanese Patent Application No. 2023-053219 filed on Mar. 29, 2023, the entire contents of which are incorporated herein by reference.

### BACKGROUND

The present disclosure relates to a manufacturing method of a structure including a plurality of square pipes that are bonded, a structure manufactured by the manufacturing method, and an image forming apparatus including the structure.

An image forming apparatus includes a sheet feed portion, a printing portion, a developer container, and the like. In addition, the image forming apparatus includes a structure which supports the sheet feed portion, the printing portion, and the developer container.

For example, the structure is known to include a plurality of square pipes that are bonded by welding. The structure having such a configuration has a high strength.

### SUMMARY

A manufacturing method of a structure according to an aspect of the present disclosure is a method of manufacturing a structure including a plurality of square pipes that are bonded and a specific member bonded to a specific pipe that is one of the plurality of square pipes. The manufacturing method can be adopted when a first through-hole is formed on a target side wall which is one of four side walls in the specific pipe and a second through-hole is formed on an opposing side wall which is one of the four side walls and opposes the target side wall. The manufacturing method includes arranging the specific member along an outer surface of the target side wall of the specific pipe. Further, the manufacturing method includes radiating laser light of a laser welder onto a first bonding region including a boundary between an edge portion of the first through-hole on the target side wall and the specific member via the second through-hole on the opposing side wall, to weld the specific pipe and the specific member in the first bonding region.

A structure according to another aspect of the present disclosure is manufactured by the manufacturing method of a structure.

An image forming apparatus according to another aspect of the present disclosure includes the structure and a printing portion which is attached to the structure and forms an image on a sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus including a structure according to an embodiment;

FIG. 2 is a perspective view of the structure according to the embodiment;

FIG. 3 is a perspective view of one of square pipes in the structure according to the embodiment;

FIG. 4 is a flowchart showing procedures of a manufacturing method of a structure according to the embodiment;

FIG. 5 is a diagram showing a positioning step in the manufacturing method of a structure according to the embodiment;

FIG. 6 is an upper perspective view showing a part of a specific pipe and specific member in the structure according to the embodiment;

FIG. 7 is a diagram showing a first welding step in the manufacturing method of a structure according to the embodiment; and

FIG. 8 is a lower perspective view showing a part of the specific pipe and specific member in the structure according to the embodiment.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

### [Configuration of Image Forming Apparatus 10]

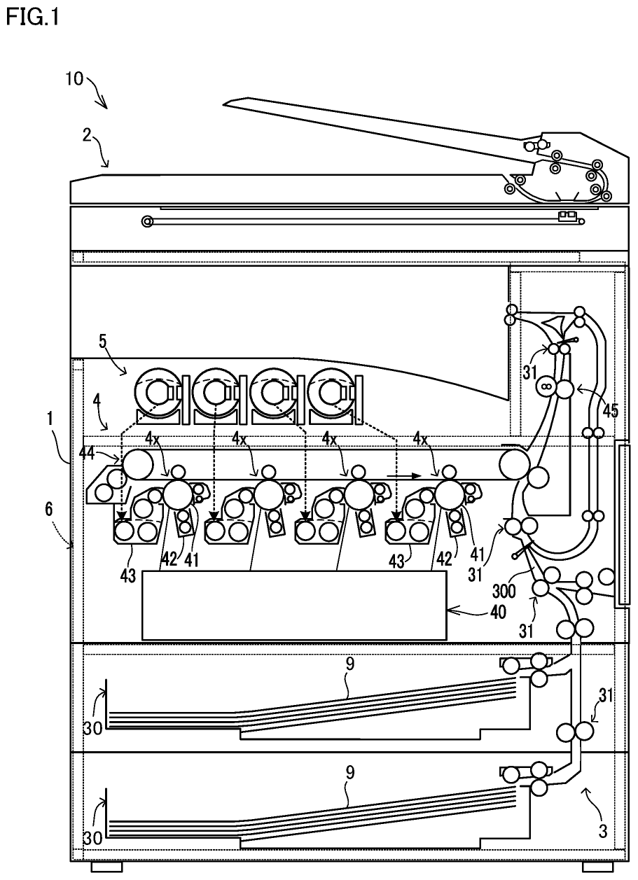

A structure 6 according to the embodiment is adopted in an image forming apparatus 10. As shown in FIG. 1, the image forming apparatus 10 includes a body unit 1 and an image reading unit 2.

The body unit 1 includes sheet feed portions 30, a sheet conveying device 3, a printing portion 4, one or more developer containers 5, and the structure 6. The image reading unit 2 is connected to an upper portion of the body unit 1. The image reading unit 2 is a device which reads an image of a document sheet.

The sheet feed portion 30 is a device which stores a plurality of paper sheets and feeds the stored paper sheets one by one to a paper sheet conveying path 300. The sheet conveying device 3 includes a plurality of sets of conveying roller pairs 31 for conveying the paper sheet along the paper sheet conveying path 300.

The printing portion 4 is a device which forms an image on the paper sheet supplied from the sheet feed portion 30 via the sheet conveying device 3. In the example shown in FIG. 1, the printing portion 4 forms an image on the paper sheet using electrophotography. The paper sheet is an example of a sheet.

The printing portion 4 that uses electrophotography includes a laser scanning unit 40, one or more image forming portions 4x, a transfer device 44, and a fixing device 45.

In the example shown in FIG. 1, the printing portion 4 is a tandem-type color image printing device. Therefore, the printing portion 4 includes four image forming portions 4x respectively corresponding to toner in four colors of yellow, magenta, cyan, and black. Further, the image forming apparatus 10 includes four developer containers 5 respectively corresponding to the four image forming portions 4x.

In each of the image forming portions 4x, a drum-type photoconductor 41 rotates to cause a charging device 42 to charge an outer circumferential surface of the photoconductor 41. Further, the laser scanning unit 40 writes an electrostatic latent image on the outer circumferential surface of the photoconductor 41, and a developing device 43 develops the electrostatic latent image into a toner image.

Furthermore, in the transfer device 44, an intermediate transfer belt 440 rotates while being in contact with the four photoconductors 41, and four primary transfer devices 441 corresponding to the four image forming portions 4x transfer the toner images onto the intermediate transfer belt 440. In addition, a secondary transfer device 442 transfers the toner images formed on the intermediate transfer belt 440 onto the paper sheet that is being conveyed along the paper sheet conveying path 300.

The fixing device 45 heats and pressurizes the toner images on the paper sheet to fix the toner images onto the paper sheet. The sheet conveying device 3 discharges the paper sheet formed with the image from the paper sheet conveying path 300.

Each of the developer containers 5 supplies toner to the corresponding developing device 43 in the printing portion 4. The toner is an example of the developer. It is noted that the printing portion 4 may alternatively be a device which forms an image on the paper sheet using an inkjet system or other systems.

The sheet feed portions 30, the sheet conveying device 3, the printing portion 4, and the developer containers 5 are attached to the structure 6. The image reading unit 2 is connected to an upper portion of the structure 6.

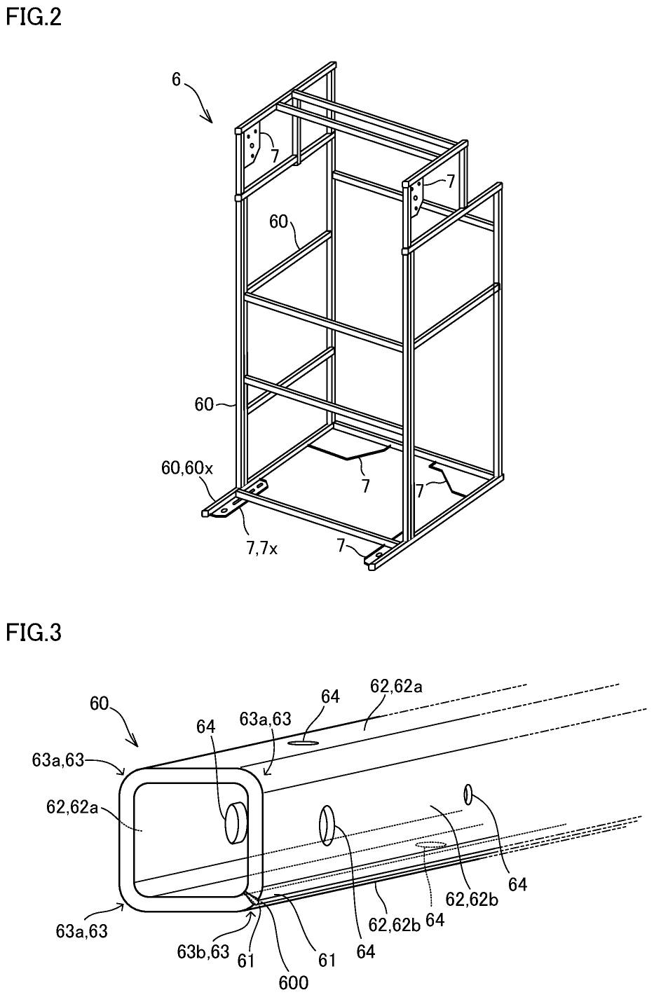

The structure 6 includes a plurality of square pipes 60 that are bonded by welding and one or more sheet-metal members 7 (see FIG. 2). The sheet-metal members 7 are manufactured by one or both of a bending process and a hole boring process with respect to a metal plate material. It is noted that the sheet-metal member 7 is an example of a metal member.

In the structure 6, the plurality of square pipes 60 formed of metal and the one or more sheet-metal members 7 are bonded by welding. Such a structure 6 has a high strength. It is noted that a metal panel may alternatively be bonded to the structure 6 by welding.

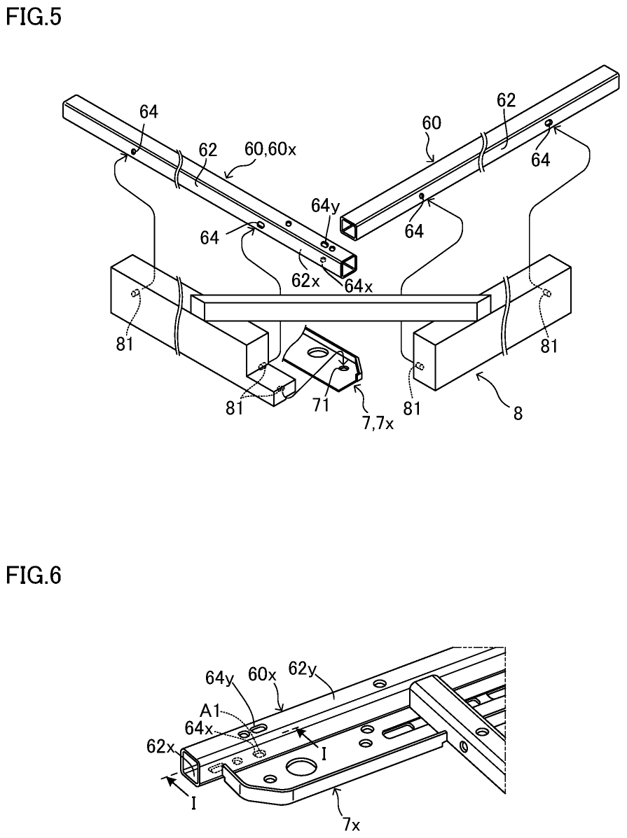

Incidentally, in the structure 6, the sheet-metal member 7 may be welded to a side surface of a specific pipe 60x that is one of the plurality of square pipes 60 (see FIG. 2 and FIG. 6). In this case, it is general to weld an outer side surface of the specific pipe 60x and the sheet-metal member.

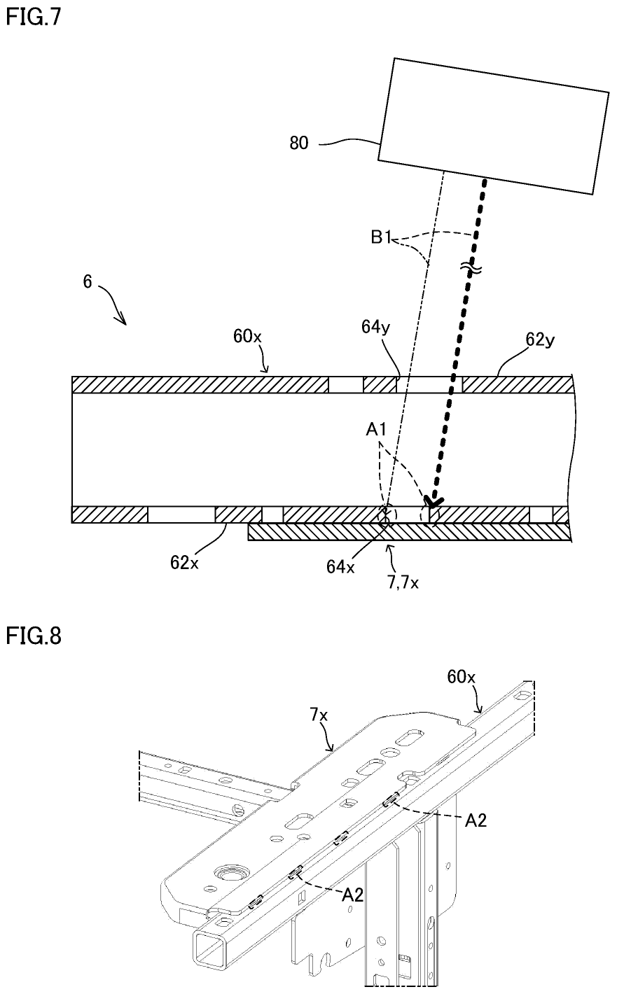

Further, when the structure 6 is mass-produced, the plurality of square pipes 60 are often welded by a laser welder 80 (see FIG. 7). In general, laser light B1 of the laser welder 80 is scanned in a state where the specific pipe 60x and the sheet-metal member 7 are retained in a constant positional relationship.

In a manufacturing scene of the structure 6, there are restrictions on a position and direction at/in which the laser light B1 of the laser welder 80 can be scanned. Similarly, there are also restrictions on orientations of the specific pipe 60x and the sheet-metal member 7 when the specific pipe 60x and the sheet-metal member 7 are retained in the constant positional relationship.

Therefore, in the manufacturing scene of the structure 6, it may be difficult to radiate the laser light B1 of the laser welder 80 onto a region including a boundary between the outer side surface of the specific pipe 60x and the sheet-metal member 7.

Hereinafter, descriptions will be given on a method that enables the specific pipe 60x and a specific member 7x arranged along a side surface of the specific pipe 60x to be welded under the situation where there are restrictions on the position and direction at/in which the laser light B1 of the laser welder 80 can be scanned. The specific member 7x is one of the sheet-metal members 7.

### [Configuration of Each Square Pipe 60]

Each of the plurality of square pipes 60 includes four side walls 62 and four corner portions 63 (see FIG. 3). The four side walls 62 and the four corner portions 63 are formed to extend in a longitudinal direction of each of the square pipes 60.

The four corner portions 63 include three first corner portions 63a and one second corner portion 63b. The three first corner portions 63a are three bent portions formed by a bending process with respect to one metal plate. The second corner portion 63b includes two edge portions 61 of the metal plate and a welding portion 600 where the two edge portions 61 are welded.

The two edge portions 61 and the welding portion 600 are formed to extend in the longitudinal direction of each of the square pipes 60.

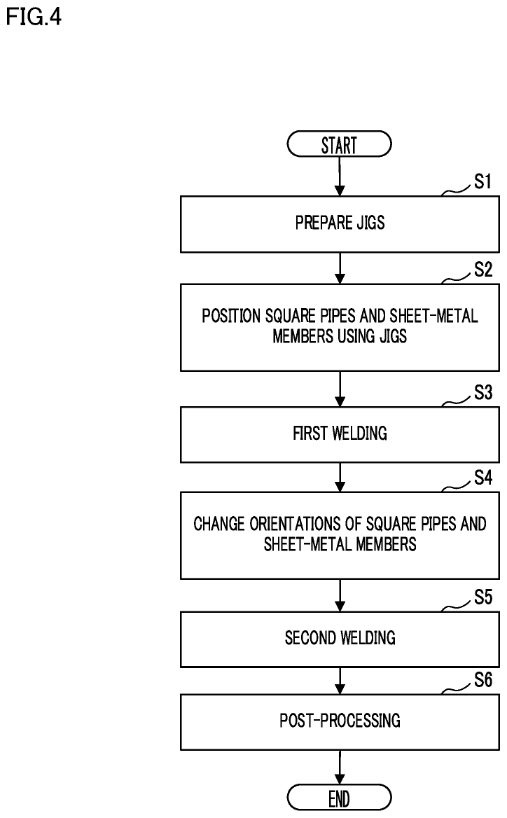

Each of the square pipes 60 includes a plurality of through-holes 64 formed on one or more side walls 62 out of the four side walls 62 (see FIG. 3 and FIG. 4). A process of the plurality of through-holes 64 in the plurality of square pipes 60 is performed on the flat metal plate before being subjected to the bending process.

Some or all of the plurality of through-holes 64 are used for attaching components. For example, the component is directly attached to one of the side walls 62 of the respective square pipes 60 by a fixing member inserted into the through-hole 64, such as a bolt and a screw.

In the present embodiment, the image reading unit 2, the sheet conveying device 3, and the printing portion 4 are attached to the structure 6 by the fixing members inserted into the through-holes 64.

It is noted that there may be a case where two or more square pipes 60 out of the plurality of square pipes 60 are members of the same type for unification of components. In this case, in some of the plurality of square pipes 60 of the same type, some of the plurality of through-holes 64 may not be used for attaching the components.

In each of the square pipes 60, any of the four side walls 62 does not include the welding portion 600. Therefore, in each of the square pipes 60, it is easy to form one or more through-holes 64 on each of the four side walls 62.

For example, four or more through-holes 64 are formed on the four side walls 62 in at least one of the plurality of square pipes 60 (see FIG. 3).

In each of the square pipes 60, the four side walls 62 include two first side walls 62a and two second side walls 62b (see FIG. 3). Each of the first side walls 62a is formed between two of the three first corner portions 63a.

On the other hand, each of the second side walls 62b is formed between one of the three first corner portions 63a and the second corner portion 63b. In other words, each of the second side walls 62b is adjacent to the second corner portion 63b.

By adopting the square pipes 60 as shown in FIG. 3 in the structure 6, all of the four side walls 62 of each of the square pipes 60 can be used for attaching the components.

In the present embodiment, the three first corner portions 63a are chamfered (see FIG. 3). Further, at the second corner portion 63b, the two edge portions 61 of the metal plate are subjected to a bending process for chamfering.

In each of the square pipes 60, the welding portion 600 may somewhat stick out from a gap between the two edge portions 61. Even in such a case, since the two edge portions 61 are chamfered, the welding portion 600 does not interfere with the components to be attached to the second side walls 62b.

### [Manufacturing Method of Structure 6]

Next, exemplary procedures of a manufacturing method of the structure 6 will be described with reference to the flowchart shown in FIG. 4.

In descriptions below, S1, S2, . . . represent identification codes of a plurality of steps in the manufacturing method of the structure 6. In the manufacturing method, Step S1 is executed first.

### <Step S1>

In Step S1, jigs 8 used for positioning the plurality of square pipes 60 and the one or more sheet-metal members 7 are prepared (see FIG. 5). The jig 8 includes a plurality of convex portions 81.

The plurality of convex portions 81 correspond to some of the plurality of through-holes 64 formed in the plurality of square pipes 60 and some of a plurality of through-holes 71 formed in the one or more sheet-metal members 7.

### <Step S2>

Next, in Step S2, the plurality of square pipes 60 and the one or more sheet-metal members 7 are positioned in a predetermined positional relationship by the positioning jigs 8 (see FIG. 5).

Specifically, the plurality of convex portions 81 formed in the jigs 8 are inserted into some of the plurality of through-holes 64 formed in the plurality of square pipes 60 and some of the plurality of through-holes 71 formed in the sheet-metal members 7 (see FIG. 5).

By inserting some of the plurality of convex portions 81 into some of the through-holes 64 of the specific pipe 60x and some of the through-holes 71 of the specific member 7x, the specific pipe 60x and the specific member 7x are positioned in the predetermined positional relationship.

It is noted that some of the plurality of through-holes 64 formed in the square pipes 60 may be dedicated holes for positioning by the jigs 8. Similarly, some of the plurality of through-holes 71 formed in the sheet-metal members 7 may be dedicated holes for positioning by the jigs 8.

The specific member 7x is one of the sheet-metal members 7 positioned by the jigs 8 (see FIG. 5 to FIG. 7). Similarly, the specific pipe 60x is also one of the plurality of square pipes 60 positioned by the jigs 8.

In Step S2, the specific member 7x is arranged along an outer side surface of a target side wall 62x of the specific pipe 60x. The target side wall 62x is one of the four side walls 62 of the specific pipe 60x.

In the present embodiment, a first through-hole 64x is formed on the target side wall 62x of the specific pipe 60x, and a second through-hole 64y is formed on an opposing side wall 62y of the specific pipe 60x (see FIG. 5 to FIG. 7). The first through-hole 64x is formed in a range where the first through-hole 64x can be seen through the second through-hole 64y when the specific pipe 60x is seen from the opposing side wall 62y side.

Each of the target side wall 62x and the opposing side wall 62y is one of the four side walls 62. The opposing side wall 62y is a side wall opposing the target side wall 62x.

### <Step S3>

Next, in Step S3, a first welding step is executed. The first welding step is executed using the laser welder 80 (see FIG. 7). FIG. 7 shows a cross section taken along an I-I plane shown in FIG. 6.

The first welding step includes welding the plurality of square pipes 60 with one another and welding some of the plurality of square pipes 60 and the sheet-metal member 7.

Further, the first welding step includes radiating laser light B1 of the laser welder 80 onto a first bonding region A1 via the second through-hole 64y on the opposing side wall 62y (see FIG. 7). Thus, the specific pipe 60x and the specific member 7x are welded in the first bonding region A1.

The first bonding region A1 is a region including a boundary between an edge portion of the first through-hole 64x on the target side wall 62x and the specific member 7x (see FIG. 7).

### <Step S4>

Next, in Step S4, orientations of the plurality of square pipes 60 and the sheet-metal members 7 bonded by the first welding step are changed. For example, the plurality of square pipes 60 and the sheet-metal members 7 are flipped vertically.

By executing Step S4, the orientations of the specific pipe 60x and the specific member 7x are changed.

In Step S4, the specific pipe 60x and the specific member 7x are already bonded by the first welding step. Therefore, it is easy to change the orientations of the specific pipe 60x and the specific member 7x while maintaining the positional relationship between the specific pipe 60x and the specific member 7x constant.

### <Step S5>

After the orientations of the plurality of square pipes 60 and the sheet-metal members 7 are changed, a second welding step is executed in Step S5. The second welding step is also executed using the laser welder 80.

The second welding step includes radiating the laser light B1 of the laser welder 80 onto a second bonding region A2 including a boundary between an outer surface of the specific pipe 60x and the specific member 7x (see FIG. 8). Thus, the specific pipe 60x and the specific member 7x are welded in the second bonding region A2.

It is noted that FIG. 8 shows a state after the change of the orientations of the specific pipe 60x and the specific member 7x.

### <Step S6>

Next, in Step S6, post-processing such as burring of the welded portion is executed. Thus, the manufacturing of the structure 6 ends.

It is noted that Step S2 to Step S5 are executed once or a plurality of times during the process of manufacturing the structure 6.

In the present embodiment, the welding of the first bonding region A1 in the first welding step is temporary welding for integrally forming the specific pipe 60x and the specific member 7x.

On the other hand, the welding of the second bonding region A2 in the second welding step is actual welding for solidly bonding the specific pipe 60x and the specific member 7x.

When the laser light B1 is radiated onto the first bonding region A1 via the second through-hole 64y, it is difficult to secure a sufficiently-large first bonding region A1. Therefore, it is difficult to solidly bond the specific pipe 60x and the specific member 7x by the welding of the first bonding region A1.

However, by welding the first bonding region A1, the orientations of the specific pipe 60x and the specific member 7x can be easily changed to orientations with which the welding of the second bonding region A2 becomes possible.

By manufacturing the structure 6 by the manufacturing method described above, the specific pipe 60x and the specific member 7x can be welded even under the situation where there are restrictions on the position and direction at/in which the laser light B1 can be scanned.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A manufacturing method of a structure including a plurality of square pipes that are bonded and a specific member bonded to a specific pipe that is one of the plurality of square pipes, the manufacturing method comprising:
when a first through-hole is formed on a target side wall which is one of four side walls in the specific pipe and a second through-hole is formed on an opposing side wall which is one of the four side walls and opposes the target side wall,
arranging the specific member along an outer surface of the target side wall of the specific pipe; and
radiating laser light of a laser welder onto a first bonding region including a boundary between an edge portion of the first through-hole on the target side wall and the specific member via the second through-hole on the opposing side wall, to weld the specific pipe and the specific member in the first bonding region.

2. The manufacturing method of a structure according to claim 1, comprising:
changing, after the welding of the first bonding region, orientations of the specific pipe and the specific member; and
radiating, after the changing of the orientations of the specific pipe and the specific member, the laser light onto a second bonding region including a boundary between an outer surface of the specific pipe and the specific member, to weld the specific pipe and the specific member in the second bonding region.

3. The manufacturing method of a structure according to claim 1, wherein
each of the plurality of square pipes includes
three first corner portions formed by a bending process with respect to one metal plate,
one second corner portion including two edge portions of the metal plate and a welding portion where the two edge portions are welded,
two first side walls each formed between two of the three first corner portions, and
two second side walls each formed between one of the three first corner portions and the second corner portion.

4. A structure manufactured by the manufacturing method of a structure according to claim 1.

5. An image forming apparatus, comprising:
the structure according to claim 4; and
a printing portion which is attached to the structure and forms an image on a sheet.
